(19) United States
(12) Patent Application Publication
(10) Pub. No.: US 2014/0278712 A1
(43) Pub. Date: Sep. 18, 2014

(54) ASSET TRACKING IN ASSET INTENSIVE ENTERPRISES

(71) Applicant: ORACLE INTERNATIONAL CORPORATION, REDWOOD SHORE, CA (US)

(72) Inventor: Moshin LEE, Lake Oswego, OR (US)

(73) Assignee: ORACLE INTERNATIONAL CORPORATION, REDWOOD SHORES, CA (US)

(21) Appl. No.: 14/213,500

(22) Filed: Mar. 14, 2014

Related U.S. Application Data
(60) Provisional application No. 61/786,428, filed on Mar. 15, 2013.
(60) Provisional application No. 61/786,441, filed on Mar. 15, 2013.
(60) Provisional application No. 61/786,451, filed on Mar. 15, 2013.

(51) Int. Cl. G06Q 10/06

(52) U.S. Cl. CPC G06Q 10/06315
USPC 705/7.25

(57) ABSTRACT

A method, system, and computer program product for asset service and maintenance lifecycle management and supply chain planning. Some embodiments commence upon receiving a database record corresponding to an individually identified asset to be individually tracked through a corresponding asset lifecycle. A supply chain ordering module generates a candidate order database entry for a component or supply as may be demanded by an asset specific scheduled maintenance plan. Having the asset specific scheduled maintenance plan, a module accesses maintenance depot database records to retrieve the asset specific scheduled maintenance plan for the individually identified asset, and the maintenance depot records are assessed to determine if the component or supply is present at the repair depot, and if so, the candidate order can be adjusted to account for the presence of the component or supply at the repair depot. The adjusted amount is forwarded to a supply chain management business application.

### RELATED APPLICATIONS

The present application claims the benefit of priority to co-pending U.S. Patent Application Ser. No. 61/786,428 entitled “METHOD AND SYSTEM TO IMPLEMENT SUPPLY CHAIN PLANNING FOR ASSET INTENSIVE APPLICATIONS” (Attorney Docket No. ORA130840-US-PSP), filed Mar. 15, 2013; and the present application claims the benefit of priority to co-pending U.S. Patent Application Ser. No. 61/786,441, entitled “METHOD AND SYSTEM TO IMPLEMENT PLANNING FOR ASSET INTENSIVE APPLICATIONS” (Attorney Docket No. ORA130841-US-PSP), filed Mar. 15, 2013; and the present application claims the benefit of priority to co-pending U.S. Patent Application Ser. No. 61/786,451, entitled “METHOD AND SYSTEM TO ANALYZE CRITICAL PATHS FOR ASSET PLANNING” (Attorney Docket No. ORA130842-US-PSP), filed Mar. 15, 2013 each of which is hereby incorporated by reference in their entirety.

The present application is related to U.S. patent application Ser. No. ______, entitled “ASSET FORECASTING IN ASSET INTENSIVE ENTERPRISES” (Attorney Docket No. ORA130841-US-NP), filed on even date herewith, which is hereby incorporated by reference in its entirety and the present application is related to U.S. patent application Ser. No. ______, entitled “RISK-AWARE PROJECT SCHEDULING TECHNIQUES” (Attorney Docket No. ORA130842-US-NP), filed on even date herewith, each of which are hereby incorporated by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

The disclosure relates to the field of service and maintenance planning, asset lifecycle management, and supply chain planning, and more particularly to techniques for improved maintenance and production planning in asset intensive enterprises.

### BACKGROUND

Many enterprises use supply chain management techniques in order to manage the flow of goods and materials throughout the enterprise. In asset-intensive enterprises, effective use of supply chain management techniques is paramount to the financial health of the enterprise inasmuch as the costs involved in asset-intensive enterprises can be very significant. On an ongoing basis, management strives to maintain the flow of goods and materials throughout the enterprise while holding only the quantities necessary in inventory and/or in other parts of the supply chain. For example, in an asset-intensive enterprise such as a commercial airline, the cost of an aircraft can be in the many hundreds of millions of dollars, thus management strives to have as many aircraft “in service” (e.g., revenue-producing) as possible, while minimizing the number of aircraft that are awaiting events that would allow the aircraft to be placed into revenue-producing service (e.g., completion of scheduled maintenance or repair). In many cases of asset-intensive enterprises, the assets are of such a nature that they are intended to have a long useful lifespan, and can be maintained so as to extend the lifespan significantly. For example, an aircraft might have a nominal useful lifespan of 20 years, however, with proper maintenance, that lifespan can be extended much longer. Other enterprises have similar approaches to maintenance cycles. In many enterprises, scheduled maintenance (e.g., scheduled vehicle safety checks, scheduled refinery equipment replacement, etc.) is based on a statute or regulation.

Unfortunately, legacy practices of supply chain management functions fail to consider materials or assets that are in a maintenance cycle. Legacy practices of supply chain management would naïvely order service parts on the basis of historical consumption. Such a naïve approach results in over- or under-ordering of parts since the characteristics and/or number of assets to be serviced and/or their operating patterns and conditions and/or needed maintenance schedules would not have been considered in the ordering practices.

As can be seen, even though certain functions of supply chain management and the functions of the operation of maintenance facilities share objectives (e.g., minimizing the number and/or duration that assets are not in service), legacy approaches have failed to integrate supply chain management functions with maintenance facilities functions.

What is needed is an integrated system where individual high-value assets (e.g., long lifetime assets) can be tracked through a lifecycle from initial ordering though asset retirement or scrap disposition. What is needed is a supply chain management function that is aware of assets in a maintenance or repair cycle. What is needed is a supply chain management function that avoids over-ordering parts and service materials for these high-value assets when it can be known that supplies from in-repair parts (e.g., defective but reparable parts) and in-repair assemblies can be used to fulfill portions of the demand.

None of the aforementioned legacy approaches achieve the capabilities of the herein-disclosed techniques for improved asset maintenance planning capabilities. Therefore, there is a need for improvements.

### SUMMARY

The present disclosure provides an improved method, system, and computer program product suited to address the aforementioned issues with legacy approaches. More specifically, the present disclosure provides a detailed description of techniques used in methods, systems, and computer program products for improved planning capabilities in asset intensive enterprises.

Some embodiments commence upon receiving a database record corresponding to an individually identified asset to be individually tracked through a corresponding asset lifecycle. A supply chain ordering module generates a candidate order database entry for a component or supply as may be demanded by an asset specific scheduled maintenance plan. Having the asset specific scheduled maintenance plan, a module accesses maintenance depot database records to retrieve the asset specific scheduled maintenance plan for the individually identified asset, and the maintenance depot records are assessed to determine if the component or supply is present at the repair depot, and if so, the candidate order can be adjusted to account for the presence of the component or supply at the repair depot. The adjusted amount is forwarded to a supply chain management business application.

Further details of aspects, objectives, and advantages of the disclosure are described below and in the detailed description, drawings, and claims. Both the foregoing general description of the background and the following detailed description are exemplary and explanatory, and are not intended to be limiting as to the scope of the claims.

### BRIEF DESCRIPTION OF THE DRAWINGS

FIG. 1A depicts an environment for practice of improved asset maintenance planning capabilities in asset intensive enterprises, according to some embodiments.

FIG. 1B depicts a system for computer-implemented practice of improved asset maintenance planning capabilities in asset intensive enterprises, according to some embodiments.

FIG. 1C1 depicts a supply chain management function to be modified for the practice of improved asset maintenance planning capabilities in asset intensive enterprises, according to some embodiments.

FIG. 1C2 depicts a supply chain management function being integrated with maintenance functions for practice of improved asset maintenance planning capabilities in asset intensive enterprises, according to some embodiments.

FIG. 1D is a flow chart for checking repair depot inventory during the practice of improved asset maintenance planning capabilities in asset intensive enterprises, according to some embodiments.

FIG. 2 depicts an asset lifecycle used in implementing improved asset maintenance planning capabilities in asset intensive enterprises, according to some embodiments.

FIG. 3 depicts selected communication paths used in a communication protocol between a supply chain management function and maintenance functions as used to implement improved asset maintenance planning capabilities in asset intensive enterprises, according to some embodiments.

FIG. 4 depicts a series of setup steps for a maintenance operations module as used in systems for improved asset maintenance planning capabilities in asset intensive enterprises, according to some embodiments.

FIG. 5 depicts a series of setup steps for an enterprise-wide asset management function as used in systems to implement improved asset maintenance planning capabilities in asset intensive enterprises, according to some embodiments.

FIG. 6A depicts a demand management module within a system for computer-implemented practice of improved asset maintenance planning capabilities in asset intensive enterprises, according to some embodiments.

FIG. 6B depicts instances of integration paths between a demand management module and other parts of a system for implementing improved asset maintenance planning capabilities in asset intensive enterprises, according to some embodiments.

FIG. 7 depicts a series of demand management operations used in systems for implementing improved asset maintenance planning capabilities in asset intensive enterprises, according to some embodiments.

FIG. 8 depicts a demand management data flow as used in systems for implementing improved asset maintenance planning capabilities in asset intensive enterprises, according to some embodiments.

FIG. 9 depicts a planning factor calculation flow as used in systems for implementing improved asset maintenance planning capabilities in asset intensive enterprises, according to some embodiments.

FIG. 10 depicts a component planning user interface as used in systems for implementing improved asset maintenance planning capabilities in asset intensive enterprises, according to some embodiments.

FIG. 11 depicts a resource planning user interface as used in systems for implementing improved asset maintenance planning capabilities in asset intensive enterprises, according to some embodiments.

FIG. 12 depicts a maintenance work order information flow diagram as used in systems for implementing improved asset maintenance planning capabilities in asset intensive enterprises, according to some embodiments.

FIG. 13 depicts an aggregation reconciliation flow for combining repair depot demands and supply chain demands as used in systems for implementing improved asset maintenance planning capabilities in asset intensive enterprises, according to some embodiments.

FIG. 14 depicts a flow for coordinating repairs with on-hand materials as used in systems implementing improved asset maintenance planning capabilities in asset intensive enterprises, according to some embodiments.

FIG. 15 depicts a flow for forecasting based on repairs and returns as used in systems implementing improved asset maintenance planning capabilities in asset intensive enterprises, according to some embodiments.

FIG. 16 is a block diagram of a system for improved asset tracking in asset intensive enterprises, according to some embodiments.

FIG. 17 is a block diagram of a system for improved asset forecasting in asset intensive enterprises, according to some embodiments.

FIG. 18 depicts a block diagram of an instance of a computer system suitable for implementing an embodiment of the present disclosure.

### DETAILED DESCRIPTION

Disclosed herein and in the accompanying figures are exemplary environments, methods, and systems for improved asset maintenance planning capabilities in asset intensive enterprises.

### Overview

Ordering capital assets (e.g., equipment, repair components, and supplies) is complex. And it becomes more complex as the size of the enterprise grows. In enterprises where the dollar value of the assets used in the enterprise is high and growing (e.g., aircraft, jet engines, refining or power generation facilities, etc.), it becomes increasingly important to manage the maintenance activities of such assets. When an asset has a maintenance schedule, the asset is taken out of service, and thus does not serve as a revenue-generating asset, at least during the time that the asset is out of service (e.g., in a maintenance facility or repair depot or by being brought down for maintenance).

Before the availability of advances as are disclosed herein, enterprises performed their supply chain management operations separately from maintenance and repair operations. In some cases, the lack of integration between the supply chain management operations and maintenance/repair operations resulted in significant negative fiscal impact. For example, an airline might have ordered a new aircraft (e.g., a 737) along with a set of replacement parts (e.g., a spare jet engine and so on) using their supply chain management tools. Separately, and at relatively the same moment in time, an older aircraft (e.g., also a 737) is taken out of service due to retirement, however the jet engines on the to-be-retired aircraft might have been recently replaced, and thus could be redeployed as a spare jet engine instead of ordering the aforementioned spare jet engine. Before the advances as are disclosed herein, the supply chain management operations would be unaware of the availability of the spare jet engine from the to-be-retired aircraft, resulting in an unnecessary purchase of the spare jet engine along with the new 737. As another example, consider the situation where a portion of a 737 fleet is being upgraded (to bring in new aircraft to the fleet), and consider that the new aircraft's maintenance schedule calls for lower frequencies of particular maintenance activities. Approaches using merely historical patterns might over-order material requirements associated with the maintenance activities. Further, consider the situation where the new assets added to the fleet are slated to fly more hours per month than were flown previously. Such effects would increase the time and material requirements associated with their maintenance schedules, and such additional materials would need to be ordered in advance of the need.

As is further described infra, the embodiments include the following features:
Individual assets are identified and tracked throughout the asset's life cycle, including initial placement into service, disposition during a scheduled maintenance cycle, disposition during an unscheduled maintenance cycle, disposition during yet other conditions that may occur during the useful lifetime of the asset, and removal from service (e.g., retirement of the asset).
The identified individual assets are tracked during performance of its own asset-specific operating plan through the useful lifetime of the asset, and events pertaining to the actual performance to the operating plan are observed and captured in a model. The model can be used to identify deviations from the asset-specific operating plan, including unplanned demands, and a statistical likelihood of such deviations are used for accurate forecasting of assets and their respective repair and maintenance components and supplies.

### DEFINITIONS

Some of the terms used in this description are defined below for easy reference.

The presented terms and their respective definitions are not rigidly restricted to these definitions—a term may be further defined by the term's use within this disclosure.
The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.
As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances.
The articles “a” and “an” as used in this application and the appended claims should generally be construed to mean “one or more” unless specified otherwise or is clear from the context to be directed to a singular form.

Reference is now made in detail to certain embodiments. The disclosed embodiments are not intended to be limiting of the claims.

### DESCRIPTIONS OF EXEMPLARY EMBODIMENTS

FIG. 1A depicts an environment 1A00 for practice of improved asset maintenance planning capabilities in asset intensive enterprises. As an option, one or more instances of environment 1A00 or any aspect thereof may be implemented in the context of the architecture and functionality of the embodiments described herein. Also, the environment 1A00 or any aspect thereof may be implemented in any desired environment.

The shown environment 1A00 includes a map over a geography (e.g., the USA, as shown) within which geography is situated a headquarters facility (e.g., HQ), a storage facility (e.g., SF) and several repair depots (e.g., Chicago repair depot RD₁, Atlanta repair depot RD₂, Seattle repair depot RD3, and another repair depot RD_{N}). As shown, functions performed at the headquarters location include supply chain management functions and some storage of inventory (e.g., in addition to the storage of inventory at the storage facility SF). The storage facility SF functions as inventory storage for some assets, some materials, and some work-in-progress assets and/or components. Also shown are repair depots where some inventory is stored. For example, a repair depot might store some materials, some soon-to-be-serviced assets (e.g., assets scheduled for maintenance events), some soon-to-be-repaired assets (e.g., assets that might need components to effect the repairs), and some expertise (e.g., mechanics, inspectors, etc.).

The shown geography approximates a nationwide operation, however embodiments and techniques as disclosed herein may be deployed into larger or smaller geographies. For example, some international airlines enjoy global reach, with facilities located in many countries worldwide, while other airlines may operate as regional airlines, and have facilities only within a particular geographic region (e.g., the southwestern five states of the United States).

In exemplary cases, the headquarters location hosts a computing facility. A headquarters location may employ a cloud service offering computing facilities that can be physically situated anywhere in the world, and enterprise management functions can be deployed on such computing facilities. Such a computing facility and an example deployment of enterprise management functions is described in FIG. 1B.

FIG. 1B depicts a system 1B00 for computer-implemented practice of improved asset maintenance planning capabilities in asset intensive enterprises. As an option, one or more instances of system 1B00 or any aspect thereof may be implemented in the context of the architecture and functionality of the embodiments described herein. Also, the system 1B00 or any aspect thereof may be implemented in any desired environment.

As shown in FIG. 1B, a computing cluster 110 can host many enterprise management functions. Strictly as an example, such enterprise management functions can be distributed across various modules, any of which modules can communicate with any other module over one or more networks (e.g., see path 105). One such enterprise management function is depicted as supply chain planning module 112. The supply chain planning module 112 communicates with a historical usage module 122 and a forecasting module 120. For example, a supply chain planning module 112 might determine from a historical usage module 122 that, on average, 43 drums of brake fluid were required in each of the preceding months, and a forecasting module 120 might determine that although the historical usage was, on average, 43 drums of brake fluid for each of the preceding months, there is a trend of a 5% increase each month, so the forecasting module might advise the supply chain planning module to order 45 (=43+5% of 43) drums of brake fluid to be available by the beginning of next month.

The foregoing depicts a supply chain ordering technique based on an aggregated history and a prediction or forecast for materials (e.g., the aforementioned drums of brake fluid). In asset-intensive environments, a particular asset might be valued at millions of dollars, and aggregation based on history and a prediction or forecast might be more capital intensive than is necessary (e.g., in an overly liberal stocking regime) or aggregation based on history and a prediction or forecast might be too parsimonious (e.g., in an overly conservative stocking regime).

To balance between an overly liberal regime and an overly conservative regime, high-value assets can be individually identified and managed through the asset's lifecycle, cradle-to-grave. For example, and as shown, the environment 1B00 might include modules to manage individual assets through maintenance cycles. A computing cluster might include modules to facilitate management of individual assets through respective maintenance cycles. For example, a maintenance schedule 114 might receive a maintenance interval schedule 123 (e.g., for required maintenance based on usage and/or time intervals), and might in turn combine it with asset management data 124 and a planned usage schedule 125. Such a maintenance scheduler can predict when an asset will need to be taken out of service for scheduled maintenance. Further, and as shown, a maintenance scheduler 114 can interact with a maintenance operations module 116, which module can serve to monitor actual in-situ maintenance operations. Strictly as one example, the maintenance scheduler 114 might indicate scheduled maintenance to service the jet engines of an aircraft, and the plan might call for a two-day out-of-service period for the aircraft, however it is possible that during the course of performance of the scheduled maintenance operation, another needed maintenance or repair becomes evident. For example, if, during the maintenance of the jet engines, inspections or other activities determine that the fuel lines are in need of replacement, the act of performing the replacement might take the jet engines, and hence the aircraft, out of service for an additional day—even if assuming that there is sufficient fuel line raw materials in stock and in the same proximity as the aircraft under maintenance/repair. Of course, this example is but one example, and many other scenarios can and do occur. Accordingly, a maintenance operations module 116 updates a work in process dataset 126. FIG. 1B also depicts a maintenance operations module 116 in communication with a demand management module 117, which has access to budgets and limits 132 as well as sales forecasts 134. The demand management module 117 is further discussed infra (e.g., see FIG. 6A).

Returning to the discussion of the supply chain planning module 112, the supply chain management might have standing instructions or rules to order two cases of snack peanuts for the aircraft for every departure, however the effect of the discovered need to replace the fuel lines and the additional one day of the aircraft being out of service (and hence several missed departures) can be recognized by the supply chain planning module such that the instructions or rules to order two cases are not carried out while the aircraft remains out of service. Further, the supply chain planning function plans the supply of materials and resources to meet requirements generated by maintenance work orders. The supply chain planning module assists in the process of choosing among options to repair, to buy new, or to transfer materials from another organization (e.g., an option selection depending upon supply chain constraints and sourcing rules, and calculated costs of selecting one option over another).

In exemplary embodiments, a complex maintenance, repair, and overhaul component (e.g., maintenance operations module 116) and/or an enterprise asset management data (e.g., asset management data 124) are integrated with a demand planning component (e.g., demand management module 117) to perform the asset management and planning. The maintenance operations module 116 provides a comprehensive view of all maintenance requirements for complex assets.

The integration of the demand planning component and supply chain planning component with the maintenance operations component allows the system to provide a comprehensive view of all maintenance requirements. This facilitates management of both scheduled and unscheduled maintenance visits as well as to aid in the acts of monitoring components, scheduling and routing jobs, optimizing supply chains, and managing maintenance documents. In addition, this integration approach also allows one to analyze trade-offs between repairing defective items and purchasing new items. The foregoing merely describes one implementation, and other partition integration techniques and operational scenarios abound. Some of such other scenarios are shown and discussed as pertains to the following FIG. 1C1 and FIG. 1C2.

FIG. 1C1 depicts a supply chain management function 1C100 to be modified for the practice of improved asset maintenance planning capabilities in asset intensive enterprises. As an option, one or more instances of supply chain management function 1C100 or any aspect thereof may be implemented in the context of the architecture and functionality of the embodiments described herein. Also, the supply chain management function 1C100 or any aspect thereof may be implemented in any desired environment.

As shown in FIG. 1C1, a supply chain planning module might be deployed to locate a needed spare part and/or materials, and in the event the spare parts or materials cannot be located, then to cause the needed spare part and/or materials to be ordered. Such a function might receive a demand for a spare part or material (e.g., fuel line material) to be made available by a certain date (see operation 1C01), and the supply chain management function proceeds to check the warehouses (see operation 1C06) and/or check for previously ordered spare parts (see operation 1C07). If the needed spare part or materials can be located (see decision 1C08), then the demand is deemed provisionally satisfied. Otherwise, the needed spare part or materials to be ordered are sent to a supply chain management function (see operation 1C10).

In some cases, in particular within the environment 1A00, it might be possible that the needed spare part or materials can be located in a repair depot. In such a case, a corresponding flow is shown and discussed as pertains to FIG. 1C2.

FIG. 1C2 depicts a supply chain management function 1C200 being integrated with maintenance functions for the practice of improved asset maintenance planning capabilities in asset intensive enterprises. As an option, one or more instances of supply chain management function 1C200 or any aspect thereof may be implemented in the context of the architecture and functionality of the embodiments described herein. Also, the supply chain management function 1C200 or any aspect thereof may be implemented in any desired environment.

As shown in FIG. 1C2, many of the operations discussed as pertaining to FIG. 1C1 are also performed by the embodiment of FIG. 1C2. The flow of supply chain management function 1C200 includes a function to check repair depots for the needed spare parts or materials (see operation 1052). This can be accomplished, for example, using the computing cluster of FIG. 1B. More particularly, some embodiments of supply chain planning module 112 will check repair depots for the needed spare parts or materials by accessing and/or carrying out a protocol exchange with a maintenance operations module 116, which access and/or protocol exchange serves to identify the needed spare parts or materials at any of a plurality of repair depots (e.g., RD₁, . . . RD_{N}). The operation to check repair depots 1052 may itself include many steps, some of which are discussed as follows.

FIG. 1D is a flow chart 1D00 for checking repair depot inventory during the practice of improved asset maintenance planning capabilities in asset intensive enterprises. As an option, one or more instances of flow chart 1D00 or any aspect thereof may be implemented in the context of the architecture and functionality of the embodiments described herein. Also, the flow chart 1D00 or any aspect thereof may be implemented in any desired environment.

As shown in FIG. 1D, the operation to check repair depots 1052 selects a candidate first depot and commences to check if the needed spare part is at the candidate repair depot (see operation 1D02). Is so, then the operation to check repair depots 1052 determines the schedule availability of the needed spare part (see operation 1D04). In some cases, the needed spare part is immediately available (e.g., it is in inventory at the candidate repair depot, and available to be transferred to the location demanding the spare part). In some cases, the needed spare part is in a soon-to-be-available state, and will become available after some time lapse (e.g., when a relatively new replacement jet engine is removed from a soon-to-be retired aircraft). In the event that the needed spare part or materials can be identified at the repair depot, then the operation to calculate the time needed to move the spare part from the repair depot to the location where the spare part is needed (see operation 1D06) serves to determine latency in availability, such as calculating in a transportation latency period needed to move the spare part from one repair depot to another repair depot after the conclusion of a scheduled repair activity. If the spare part can be relocated in time (see operation 1D07), then the identified spare part can be considered as a candidate to satisfy the demand (see operation 1D08). In other cases the needed spare part cannot be located or cannot be relocated in time, so other repair depots are checked (see operation 1D10).

The foregoing discussion introduces the lifecycle states of an in-service asset or spare part, an out-of-service asset or spare part, and a retired asset or spare part. A cradle-to-grave asset or spare part lifecycle is briefly discussed as follows.

FIG. 2 depicts an asset lifecycle 200 used in implementing improved asset maintenance planning capabilities in asset intensive enterprises. As an option, one or more instances of asset lifecycle 200 or any aspect thereof may be implemented in the context of the architecture and functionality of the embodiments described herein. Also, the asset lifecycle 200 or any aspect thereof may be implemented in any desired environment.

As shown in FIG. 2, an asset (e.g., a spare part) might be purchased (e.g., using a supply chain planning module 112) and the new asset placed in service (see path 202). Once placed in service (see stage 204) the asset is deemed available for use. At some point in time, the asset might be subjected to scheduled or unscheduled maintenance (see stage 206) and during the performance of the maintenance, the asset is deemed out of service, and in some situations it is possible that the asset is retired or scrapped (see stage 299). In some cases the maintenance can be simple (e.g., change the brake fluid). In other cases the maintenance is complex, and may involve work breakdown (e.g., in the form of one or more work task lists), and may involve components needed to perform the maintenance, for example, “two sets of brake pads”, if the inspection deemed that brake pads are needed (see stage 208). In many cases, the work task lists cannot be completed until any/all needed components and/or materials are available at the job site. Accordingly, the lifecycle includes steps to secure components (see stage 210), which may or may not further include steps to secure components from inventory (see path 212, operation 214, and path 216). It is possible that the operation to check inventory determines that no such components are available and, if so, the advance through the lifecycle might include ordering a new component (see path 218). Ordering a new component can be facilitated by a using a supply chain planning module 112, as shown. When the components are secured and the work is done (see stage 220), processing advances through the lifecycle.

As can be understood from the foregoing, progression through a lifecycle can be facilitated using a supply chain planning module that is in communication with a maintenance operations module. Such communication between a supply chain planning module and a maintenance operations module is now briefly discussed.

FIG. 3 depicts selected communication paths used in a communication protocol 300 between a supply chain management function and maintenance functions as used to implement improved asset maintenance planning capabilities in asset intensive enterprises. As an option, one or more instances of communication protocol 300 or any aspect thereof may be implemented in the context of the architecture and functionality of the embodiments described herein. Also, the communication protocol 300 or any aspect thereof may be implemented in any desired environment.

As shown in FIG. 3, the communication paths used in a communication protocol between a supply chain management function and a maintenance operations module carries information in both directions. Strictly as one example, any forms of a work order (e.g., maintenance work order 317 and/or repair work order 314) can be communicated to supply chain planning module 112, either individually (e.g., via maintenance work order 317) or in combination (e.g., via maintenance and repair work orders 314). Such a work order might refer to upcoming maintenance events (e.g., scheduled maintenance) or it might refer to unscheduled events that occurred during the performance of scheduled maintenance.

The supply chain planning module can be configured to plan for provisioning of needed materials and resources for any sorts of work orders such as repair work orders 314 (see operation 302), and the supply chain planning module can be configured to plan for provisioning of needed materials and resources for overhaul work orders (see operation 304). Additionally the supply chain planning module can be configured to plan the flow of defective items (see operation 306). Both the shown supply chain planning module 112 as well as the maintenance operations module 116 can create maintenance work orders (see operation 308). For example, and as shown, the supply chain planning module 112 can create work orders in the form of maintenance work orders 317. The maintenance operations module 116 can create work orders in the form of repair work orders 314. Work order can flow between modules over integration path 301₁ and/or over integration path 301₂.

The operations shown within the maintenance operations module 116 include operations to create maintenance plans for assets (see operation 310), retrieve asset location data from asset management data 124 (see operation 311), retrieve planned usage schedule (see operation 312), and create detailed repair and overhaul work orders (see operation 313).

In the shown partitioning, the supply chain planning module 112 generates work orders corresponding to scheduled maintenance events, and the supply chain planning module 112 can forecast availability of any sorts of materials, equipment and/or supplied, shown as forecasted availability 316 (see integration path 301₁). The maintenance operations module 116 generates work orders corresponding to actual in-situ maintenance events (see path integration 301₂). The foregoing partitioning is merely one possible partitioning. Other partitions are possible, some of which alternative partitioning is discussed herein.

Following the partitioning given by the modules of FIG. 3, the maintenance operations module 116 and the supply chain planning module 112 can be configured prior to or during operations. Exemplary set-up scenarios for the maintenance operations module and for the supply chain planning module are discussed in the following FIG. 4 and FIG. 5, respectively.

FIG. 4 depicts a series of setup steps 400 for a maintenance operations module as used in systems for improved asset maintenance planning capabilities in asset intensive enterprises. As an option, one or more instances of setup steps 400 or any aspect thereof may be implemented in the context of the architecture and functionality of the embodiments described herein. Also, the setup steps 400 or any aspect thereof may be implemented in any desired environment.

As earlier indicated, in some embodiments, high-value assets can be individually identified and managed through the asset's lifecycle. The series of setup steps 400 includes defining assets (see operation 402). Assets can be defined by name or serial number or other ID and/or by class of asset. Further, an asset might be deemed to be a collection of assets, each constituent asset or component with its own serial number (see operation 404). For example, a jet engine might have a particular serial number, and so might the fuel pump have a serial number, and so might the cowing have a serial number, and so on.

In some cases, in particular where an asset is a complex piece of equipment (e.g., an aircraft), it might be reasonable to define maintenance requirements per asset and/or per unit (see operation 406). Again, in some cases, a particular asset might be associated with a particular in-service schedule (e.g., scheduled passenger carriage from one city to another city), and the asset might be associated with any number of in-service plans (see operation 408). In some cases, the combined information of the asset and its in-service plans allows for planning vis-à-vis supporting infrastructure to facilitate use of the asset in accordance with the in-service plans (see operation 410). For example, if an aircraft is scheduled to fly three legs (e.g., from Atlanta to Chicago to Seattle), and the number of hours flown by that aircraft by the time it reaches Chicago coincides with scheduled brake maintenance, it might be reasonable to configure “Chicago” as a candidate repair depot for the aircraft. Or, if the Chicago site cannot satisfy the materials or resource requirements for the schedule maintenance, then another site might be configured as a candidate repair depot for the aircraft. Additional configurations might come in the form of associating one or more organizations with an asset. For example, an aircraft with a particular serial number or “tail number” might be associated with a particular affiliate.

Given some or all of the aforementioned configurations, maintenance plans can be constructed (see operation 414). In some cases scheduled maintenance plans are determined in part by a simulation that considers the combination of mandatory maintenance (e.g., inspect brake pads every 30 landings) with planned usage (e.g., fly from Atlanta to Chicago, and on to Seattle one each weekday). Since the planned location of the asset and the planned maintenance are both known, operations within the setup steps 400 can forecast maintenance work orders that coincide with the planned usage (see operation 416).

Any or all of the foregoing configurations can be provided to a maintenance operations module (e.g., see maintenance operations set-up as depicted in FIG. 3).

FIG. 5 depicts a series of setup steps 500 for an enterprise-wide asset management function as used in systems to implement improved asset maintenance planning capabilities in asset intensive enterprises. As an option, one or more instances of setup steps 500 or any aspect thereof may be implemented in the context of the architecture and functionality of the embodiments described herein. Also, the setup steps 500 or any aspect thereof may be implemented in any desired environment.

The flow shown in FIG. 5 depicts one possible set of steps for configuring a supply chain planning module such as is shown in FIG. 3. One of the functions of a supply chain planning module is to order items that are needed or can be predicted to be needed. In many environments many suppliers and/or channels (collectively, sources) may exist, any of which might be able to satisfy an order for an item under certain terms (e.g., price, delivery schedule, etc.). The flow commences by collecting data (e.g., catalog information, ordering information, etc.) pertaining to any/all of the sources (see step 502) and then defining and applying rules pertaining to the ordering conditions for the items (see step 504). In a complex setting such as the environment 1A00, and in particular when the aforementioned items carry a high value (e.g., an aircraft or a jet engine, etc.), specific items might be sourced in accordance with a plan. For example, an airline might plan to buy five new 737's in the upcoming year, and might plan to contemporaneously replace jet engines on four 737's from their fleet. In such cases, a given item might be tagged with attributes that correspond to the plan (see step 506). Further, items or groups of items might be conveniently handled as an asset, and assets might be handled conveniently as asset groups. Accordingly, assets are defined (e.g., possibly as collections of items), and assets are grouped in accordance with a hierarchy or taxonomy (see step 508). Still further, any given asset might be associated with equipment or other resources. For example, a jet engine from a 737 can be serviced by any mechanic who has been certified to work on such a jet engine. Or, for example, a jet engine from a 737 needs a particular tool in order to be serviced. Any asset can be linked to multiple units of equipment and/or linked to other resources (see step 510).

Still discussing these configuration steps, an asset can be characterized as a rebuildable item (see step 512), and an asset (e.g., a rebuildable item) can carry an association with a maintenance schedule and/or specific maintenance activities (see step 514). Any one or more maintenance schedule or activity can be associated with lead times and routings. For example, a rebuild and overhaul of a jet engine has a lead time of two days (e.g., to remove the jet engine from the airframe) and has a routing that includes a two-day stop in “Hangar 1” along with the airframe, and then is routed for five days to “Hangar 2” where the rebuild and overhaul operations take place (see step 516).

It sometime occurs that, in the course of performing a rebuild and overhaul operation, a local inventory is accessed. In some cases the local inventory is stocked with “on hand” components or materials. In some cases the local inventory is added to when usable components from an otherwise retired asset is disassembled. Depending on the value of the component(s) it might be reasonable to ship the component(s) to a main inventory location. In still further cases a local inventory can contain defective parts that might become usable, or might be repaired by the original suppler. The configuration flow of FIG. 5 handles these cases, including defining one or more sub-inventories for handling rebuildable and/or defective components (see step 518). For example, a sub-inventory can be defined to be a partition (e.g., a virtual partition) within an inventory, and can used to separate parts according to various business criteria such as part condition (e.g., usable, defective, etc.) or part grade (e.g., AAA, AA, A, B, etc.)

In a complex setting such as the environment 1A00, and in particular when the aforementioned items carry a high value (e.g., an aircraft or a jet engine, etc.), specific items might be maintained in accordance with a maintenance plan, and a supply chain planning module can be employed to ensure that the needed items, components, parts, materials and other resources can be sourced in time for the activities within the maintenance plan. This embodiment addresses such sourcing by processing a preventative maintenance schedule (see step 520) so as to generate a plan at the work order level of detail (see step 522). In exemplary cases, a work order has sufficient detail (e.g., who, what, when, where) such that a forecast (e.g., of items to order or take from stock) can be generated and compared with budgets (see step 524).

In another usage of the series of setup steps 500, the data collected from the maintenance operations module pertains to specific assets (e.g., assets with a serial number). Such data can comprise maintenance schedules, maintenance materials required, maintenance personnel or other required resources (e.g., technicians with special skill levels or special facilities), and operational information about the assets along with various attributes identified for defining the assets. Sourcing rules are defined and are assigned to items being analyzed. For example, a “Repair At” rule could be defined that indicates that supply for the item could be created in an organization by repairing a defective item and producing a usable one. Another example rule is the “Buy From” rule, which indicates that the item could be purchased from the specified supplier/supplier site. A “Transfer From” rule could be used to indicate that the item could be transferred from the specified source organization. This could apply to either defective or usable items. A “Make At” rule could be used to indicate that the item is manufactured in a given organization.

Further, planning-specific attributes can then be set. For example, attributes pertaining to “Rebuild Activity” can be set to configure a bill of materials (BOM) and routing attributes associated with rebuild activities. As another planning-specific attribute example, a “Scrap Rate” attribute can be configured to set the rate at which an item is scrapped as it gets removed from service.

The shown flow ends upon generation of maintenance work orders (e.g., see step 522 and step 524). Any or all of the aforementioned configuration steps can be performed in advance of any given execution of functions within a supply chain planning module and/or any or all of the steps can be performed at any time (e.g., for purposes of updating the configuration through the progression of time).

FIG. 6A depicts a demand management module within a system 6A00 for the computer-implemented practice of improved asset maintenance planning capabilities in asset intensive enterprises. As an option, one or more instances of system 6A00 or any aspect thereof may be implemented in the context of the architecture and functionality of the embodiments described herein. Also, the system 6A00 or any aspect thereof may be implemented in any desired environment.

As given in the foregoing discussion pertaining to FIG. 5, a supply chain planning module can be configured so as to facilitate forecasting in accordance with a maintenance schedule. In some cases, a maintenance schedule is purely interval-based (e.g., replace the tires once each year or sooner). In other cases, a maintenance schedule is based in part on usage (e.g., replace the tires once every 600 landings or sooner). In still other cases a maintenance schedule (e.g., for a component) is based on another maintenance schedule. For example, “replace the door seals whenever the landing gear is opened for inspection or maintenance.”

As can be seen, forecasting the demand for parts (e.g., “door seals”) and components is related to the maintenance schedule. Also, a maintenance activity might be initiated based on regularly scheduled interval maintenance, or it might be initiated based on on-demand maintenance (e.g., a system alert indicates landing gear doors did not close properly). Still other situations and/or occurrences might precipitate the need for a maintenance event, and any or all of such situations and events can be modeled and/or monitored in a maintenance operations module 116. When a maintenance event commences, the specific maintenance event might call for parts and/or components and/or other resources. Such a demand can be modeled and/or monitored by a demand management module 117, and a demand management module can interact cooperatively with the maintenance operations module 116. In some embodiments, the demand management module can interact directly or indirectly with a supply chain planning module 112 (as shown).

Various embodiments and various interactions and various integration paths between the aforementioned modules are further discussed in FIG. 6B.

FIG. 6B depicts instances of integration paths 6B00 between a demand management module and other parts of a system for implementing improved asset maintenance planning capabilities in asset intensive enterprises. As an option, one or more instances of integration paths 6B00 or any aspect thereof may be implemented in the context of the architecture and functionality of the embodiments described herein. Also, the integration paths 6B00 or any aspect thereof may be implemented in any desired environment.

The depiction of FIG. 6B graphically illustrates the integration between the maintenance operations module 116 and the demand management module 117. In one embodiment, the integration commences by having the demand management module 117 import data from the maintenance operations module 116. The imported data includes, for example, information about historical and projected fleet size, historical and projected fleet utilization, and historical and projected visits and usage.

In systems such as are hereinabove described, individual assets are individually tracked during performance of their own asset-specific operating plans through the useful lifetime of the asset. Events pertaining to the actual performance of the operating plan is observed and captured in a model. The model can be used to identify deviations from the asset-specific operating plan, including unplanned demands, and a statistical likelihood of such deviations are used for accurate forecasting of assets and their respective repair and maintenance components and supplies. Strictly as examples, forecasting might include planning factors describe as:
Order 10% more of “Supply1” on each ordering cycle.
Order 10% less of “Supply2” on each ordering cycle.
Order one unit of “PART2” at least two weeks in advance of whenever “PART1” is scheduled for maintenance.
Allocate an additional three units of “ResourceA” whenever a specific maintenance activity “MaintAB” is started.

Planning factors (e.g., such as just heretofore described) relate the type of maintenance activity to be performed to the material quantities and resource hours required. Material and resource demand forecasts are configured and/or calculated based at least in part on planning factors. Such demand forecasts can originate from the demand management module 117 (also see FIG. 9). In addition, the demand management module originates plan forecasts that are related to activities other than maintenance (e.g., non-maintenance activities). The demand management module exports planning factors (see path 612) to the maintenance operations module. The planning factors can be used in various calculations in the system, and planning factor calculations can occur at various levels of aggregation. For example, planning factors can be used to accurately calculate material requirements for each maintenance activity using a technique that considers both planned and unplanned material requirements. A planning factor calculation module can be defined and used/reused within any module. Strictly as examples, planning factor calculations can consider: (a) operating fleet originating maintenance requirements, (b) maintenance visit characteristics, (c) maintenance visit progression, and/or (d) operating fleet type (also see FIG. 9).

As shown, the demand management module is capable of exporting both maintenance forecasts (see path 602) as well as non-maintenance forecasts (see path 604) to locations (e.g., staging tables) within or accessible by the supply chain planning module 112).

Further integration paths include paths from the demand management module to other components. Strictly as one example, the shown maintenance operations module provides an input to the demand management module in the form of historical maintenance demand (see path 608). The demand management module can record any aspect of maintenance work in process (e.g., see work in process dataset 126), and a history of work even after the work has been completed can be stored in and retrieved from the work in process dataset 126 (e.g., see history of maintenance work records 128₁, and history of maintenance work records 128₂). Thus, a history of maintenance work and a series of historical maintenance demands can be retrieved from a history of maintenance work database and/or the work in process dataset 126 and/or from a historical usage module 122, and delivered to the demand management module 117 (e.g., see path 608).

In some embodiments, the demand management module 117 comprises a learning model 610 and a predictor 620. The learning model can be trained by the observations corresponding to events named or suggested within the history of maintenance work. The training of the learning model can be continuously updated over time so as to learn the ongoing patterns or other characteristics pertinent to the maintenance events. Such learned patterns can be used in conjunction with a predictor 620. A learning model 610 can learn by observations (e.g., via a historical usage module 122) and/or in the form of historical maintenance demands (e.g., see path 608) that, for example, “in 90% of occurrences of scheduled maintenance event “A”, an unscheduled maintenance event “B” also occurs.” A predictor can then be used in conjunction with supply chain management. In this example, if maintenance event “A” is “repair and overhaul the jet engine” and unscheduled maintenance event “B” is “an aft mounting bracket has been inadvertently destroyed and must be replaced”, then the learning module captures that in 90% of occurrences of “repair and overhaul the jet engine”, an. unscheduled maintenance event to replace an aft mounting bracket also occurs. The predictor can then predict to a statistical certainty that an aft mounting bracket should be ordered in advance whenever a scheduled maintenance event “repair and overhaul the jet engine” is slated to occur. Over time, processing of historical materials and resource usage data and historical/future population can result in planning factors (e.g., operating tempo, operating conditions of maintained assets, etc.), and such planning factors can be calculated by a demand management module and sent to a maintenance operations module (e.g., see path 612).

In operation, the supply chain planning module 112 component interacts with the demand management module 117 and with the maintenance operations module 116 components to perform asset intensive planning. The supply chain planning module 112 receives current and forecasted maintenance work orders from maintenance operations module 116 and also receives demands from the demand planning component. The supply chain planning module 112 performs planning of materials and resources for the maintenance work orders. In addition, supply chain planning module 112 performs planning of materials and resources for repair work orders as well as for the flow of defective items in the supply chain. Constraints (e.g., material and resource capacity and sourcing constraints) are applied to the plan. The supply chain planning module then releases the repair, new buy, and transfer orders.

FIG. 7 depicts a series of demand management operations 700 used in systems for implementing improved asset maintenance planning capabilities in asset intensive enterprises. As an option, one or more instances of demand management operations 700 or any aspect thereof may be implemented in the context of the architecture and functionality of the embodiments described herein. Also, the demand management operations 700 or any aspect thereof may be implemented in any desired environment.

In certain situations (e.g., in an asset intensive enterprise), a manager might want to coordinate ordering by considering demands and/or forecasted demands from all possible sources from within the organization. For example, a manager might want to coordinate ordering by considering demand for components and supplies used in building product. In addition, a manager might want to coordinate ordering by considering demand for components and supplies used in maintenance of enterprise assets. Further, in certain situations, there can be substantial latency between placing an order and when the order is received and inspected, certified and/or placed in a location to be used. Especially when there is a latency between ordering and actual availability for use, a manager might want to have a forecasting facility. Such a forecasting facility can produce an accurate forecast (e.g., at least to a calculable statistical certainty). Such a forecasting facility might be implemented using a demand management module 117 using the operations and/or modules shown in FIG. 7.

In the series of demand management operations 700, maintenance related demands and non-maintenance related demands might be calculated separately and later combined. Further, a learning model 610 and a predictor 620 might be employed to identify demands that have been learned to re-occur in the past, and can be predicted to re-occur again in the future—at least to a statistical certainty or uncertainty. The shown traversal of operations commences in a non-maintenance demand calculator 701, for example, by importing a non-maintenance history of demands (see operation 704). The non-maintenance history (e.g., history of demands from other sources) can be used to generate a non-maintenance forecast (e.g., see operation 708).

The demand management module can further calculate maintenance demand. As shown, a maintenance demand calculator 711 commences by importing historical maintenance demands (e.g., from the work in process dataset 126) over path 710, and pre-processes the historical maintenance demands (e.g., see step 712) into a form to be used in conjunction with the learning model 610 and predictor 620 to generate a maintenance-related forecast for assets, components, parts, materials, etc. that considers the actual historical demands in combination with predicted demands in order to generate a forecasts (e.g., see operation 708). The non-maintenance demand forecasts and the maintenance-related demand forecasts can be combined in a later step (e.g., see step 714 and path 705).

In some situations, the aforementioned combined forecast is checked against budgets and limits (e.g., see step 716) and/or variance to historical norms (e.g., see step 718). It is sometimes possible that a forecast or prediction presents demands (e.g., for ordering) that exceed budgetary constraints (e.g., maximum spending) for a particular period. Also, it is sometimes possible that a forecast or prediction presents demands (e.g., for ordering) that are below constraints (e.g., below contractual minimum ordering limits or other minimums) for a particular period. Accordingly, certain operations within the demand management module 117 serve to compare against budgets, minimums, and other and limits (e.g., step 716). Further, certain operations within the demand management module 117 serve to quantify variability (e.g., see step 718).

Some embodiments collect and process cost data, which cost data is populated into staging tables. Cost data might include production costs, purchase costs, repair costs, and ‘resource hour’ costs. The costs may be adjusted by a cost adjustment factor, which can be used to adjust costs in accordance with the passage of time so as to model varying costs over time. The adjustment may be implemented by using an index or by using an exchange rate.

A value to quantify demand variability is calculated. Demand variability can be used to smooth out large swings in forecasts. One practice involves comparing an archived forecast to current aggregated demand. If the current aggregated demand for the current period varies significantly from historical values for the same item in a corresponding period, then the demand variability is high, and statistical measures can be calculated so as to order only enough so as to achieve a given likelihood of availability. Further, costs incurred by over-ordering or under-ordering can be calculated so as to arrive at a cost-effective order amount. For example, if, on average, 430 quarts of lubricant are needed in a given period of time, but once every 50 periods of time 860 quarts are needed, then a calculation can be performed to compare the costs of ordering and carrying the 860 quarts versus the cost of the option of not having the 430 quarts at the time it needed. If the calculated cost of not having the lubricant for a certain period of time (e.g., the time an aircraft is taken out of service awaiting lubrication) is higher than the calculated cost of carrying the excess (e.g., the cost of carrying inventory) then the lower cost option is selected. In the foregoing example, the probability is 95% that when a demand for lubricant arises, it can be fulfilled from lubricant in stock. In one scenario, if the cost of not having the full quantity of lubricant once in 50 cycles (e.g., and sourcing upon that need) is lower than the calculated cost of carrying the excess 430 quarts, then the lower cost option of not carrying the excess is selected. However, in another scenario, if the calculated cost includes (for example) the cost of having a revenue-generating asset out of service, then the cost of carrying the excess 430 quarts might be more acceptable than additional out of service down-time.

Still other steps constituent to demand management operations 700 can be performed before exporting an adjusted forecast to the supply chain planning module. As shown, a combined maintenance-related and non-maintenance related forecast can be generated (e.g., see step 720) and the combined forecast can be adjusted to order enough to satisfy demands at least to a statistical likelihood (see step 722) before exporting the adjusted forecast (see step 724) to the supply chain planning module (see path 726).

FIG. 8 depicts a demand management data flow 800 as used in systems for implementing improved asset maintenance planning capabilities in asset intensive enterprises. As an option, one or more instances of demand management data flow 800 or any aspect thereof may be implemented in the context of the architecture and functionality of the embodiments described herein. Also, the demand management data flow 800 or any aspect thereof may be implemented in any desired environment.

The demand management data flow 800 presents a partitioning of the operations of FIG. 7 into three modules, namely a maintenance and service component forecasting module 802, a sales and installed base forecasting module 804 and a supply chain coordination module 806.

The maintenance and service component forecasting module 802 receives inputs, including a component usage history 822 and a historical and planned asset usage 824. Such inputs can be combined to determine planning factors that influence the execution of maintenance. As an example, suppose that, historically, each time a jet engine of a 737 is serviced for routine maintenance, 45 quarts of lubrication oil is used. And further suppose that there are 10 occurrences for routine maintenance scheduled for the next period. Then it might follow that 450 quarts of lubrication oil will be used in the next period. This quantity “450 quarts of lubrication oil” might become an order to be executed by the supply chain planning module, or it might be reduced on the basis of lubrication oil in inventory, or perhaps it might be reduced on the basis of a bulk purchase that was made in a previous time period.

The sales and installed base forecasting module 804 considers the particularities of forecasting vis-à-vis new assets (e.g., see new asset in service schedule 826) and/or components and/or tools and/or materials, etc. Further, the sales and installed base forecasting module 804 considers the particularities of forecasting with respect to a sales forecast (e.g., see sales forecast 828). On an ongoing basis, the components and/or tools and/or materials needed to satisfy a build in accordance with a sales forecast are considered.

The supply chain coordination module 806 takes in maintenance work orders 317 and possibly other forms of maintenance-related ordering plans, and combines them with non-maintenance ordering plans 832. Such inputs can be combined with the aforementioned new asset in service schedule 826 and combined with the aforementioned sales forecast 828 so as to avoid under ordering or over ordering.

In a further embodiment of this disclosure, a highly detailed demand schedule and set of planning factors are generated. To do so, the shown embodiment includes processing of historical materials and resource usage data and historical/future population, operating tempo, and operating conditions of maintained assets that are sent from a maintenance operations module 116 and received by the demand management module 117. The demand management module 117 calculates planning factors that determine the statistical quantities of spare parts and hours of resource effort required to perform different kinds of maintenance activities. Such a demand schedule and planning factors are sent to the maintenance operations module 116 so that its future estimates of material and resource effort for different types of maintenance activities can be made more accurate. The demand management module 117 also calculates projected materials and resource requirements for alternative maintenance scenarios (e.g., characterized by different operating tempos, operating conditions, quantities of assets to be maintained, preventative maintenance programs to be undertaken, among other characteristics), and allows these projections to be compared against financial budgets and/or limits (e.g., budgets and limits 132). The demand management module 117 also calculates a measure of statistical error for its projection or forecast of materials requirements, which can be used when calculating optimal inventory level targets throughout the maintenance supply chain.

In one embodiment of this disclosure, the materials requirement forecast and the forecast error generated by a demand management module 117 is fed into an inventory optimization system (e.g., inventory optimization module 127), which prescribes target time-phased safety stock levels for all maintenance parts across all maintenance locations in order to buffer against demand and supply uncertainty with the minimum possible overall inventory levels. The output of such an inventory optimization system, along with the materials forecast from a demand management module 117, along with maintenance plans for individually maintained assets from a maintenance operations module 116 system, are provided to supply chain planning module 112 which in turn prescribes the timing, quantity and location of spare parts repairs, new spare parts procurement, and characteristics of complex subassembly repairs. The recommendations from the supply chain planning module 112 are provided to the maintenance operations module 116 to create the necessary repair orders and to a purchasing system (e.g., purchasing module 129) to create the necessary new buy purchase orders.

In one embodiment of this disclosure, and again referring to FIG. 6A, the maintenance work orders from multiple maintenance visits to be scheduled at a given maintenance location are fed from a maintenance operations module 116 to a maintenance scheduler 114, which produces scheduled maintenance plans. In producing a scheduled maintenance plan 119, the maintenance scheduler 114 takes into account the required work breakdown structure of the maintenance work orders (for example, which orders have to be done before which others, which orders comprise a visit stage or milestone that has to be completely finished before work on a downstream stage can start) and the available maintenance personnel, resources, and materials then sequences the maintenance work orders so as to maximize the visit throughput of the maintenance facility. The maintenance scheduler provides diagnostics such as critical path information to help maintenance schedulers to determine how to pull in visit completion dates and maximize visit throughput.

The aforementioned planning factors can be generated in accordance with a profile, and some embodiments provide a user interface (e.g., profile set-up module 901) to facilitate set-up and initialization of data structures used in planning factor calculations. An exemplary flow is now briefly discussed.

FIG. 9 depicts a planning factor calculation flow 900 as used in systems for implementing improved asset maintenance planning capabilities in asset intensive enterprises. As an option, one or more instances of planning factor calculation flow 900 or any aspect thereof may be implemented in the context of the architecture and functionality of the embodiments described herein. Also, the planning factor calculation flow 900 or any aspect thereof may be implemented in any desired environment.

As shown in FIG. 9, a planning factor calculation module 903 includes operations to analyze maintenance work orders (e.g., see step 902) as well as operations to analyze new asset data (e.g., see step 904 and see new asset in-service schedule 826). Using the maintenance work orders and new asset data, planning factors can be calculated (e.g., see step 906) and exported (e.g., see step 908).

The particular calculations and formatting of the exported planning factors can be configured using a profile. Such a profile can be set up using a user interface, which can capture and store user-specified planning factors (see step 910). For example, various user-specified profile items (e.g., time granularity step 912) are used in a schema for representing the progression of plans and/or to characterize the progression of plans over a time period. A given plan of any sort can be decomposed and normalized into breakdown schedules in accordance with the user-specified profiles (e.g., a breakdown schedule may be modeled to the granularity of days, or hours, or minutes, or seconds or at any other time granularity).

Some embodiments collect work order history and/or material and resource usage history, and use information thereto in preparation of planning factors that can in turn be used to generate work orders. In some cases, work order data will have the organization of an associated visit type. Strictly as examples, in addition to component, materials and planning factors, a work order can comprise:
A date. The date of a work order will be the ‘actual_start_date’ if available, else the ‘scheduled_start_date’ of the associated work-in-process (WIP) job.
A status code. Work orders can be filtered based on status_code (e.g., Closed, Completed, Complete No-charge, etc.).

In some cases (e.g., an airline) operations can include consideration of aspects of assets characterized as a fleet (e.g., a fleet of aircraft). Fleet data might include fleet size, fleet flight hours, fleet number of missions, and so on.

In some cases, the calculated planning factor refers to the ratio between work orders and underlying material and resource usage. The result is the average amount of given material or resources that will be required for a particular work order having specific attributes. For example, for each spare in a spares inventory (e.g., see spares inventory 1503 of FIG. 15), a planning factor can be calculated. Planning factors can be specified per item (e.g., component, tool, material, resource). Some planning factors characterize the average number of component spares and/or resource hours required when performing a specified maintenance operation. For example, if an engine check requires a new hydraulic pump 20% of the time, the planning factor for the hydraulic pump would be 0.2.

In some embodiments, the highest planning factor for a visit can be used as an overriding pessimistic or worst-case planning factor. Or the lowest planning factor calculated for a visit can be used as an overriding optimistic or best-case planning factor. In some cases planning factors are interpreted in aggregation. One interpretation involves averaging the underlying planning factors. Other interpretations involve use of weighted average values.

A plan (e.g., a plan incorporating the above planning factors) can be formed for any given asset, component, part, material, or other resource, and such a plan can be presented to a user using a user interface screen (e.g., a component planning user interface, resource planning user interface), examples of which are shown and described in the following figures.

FIG. 10 depicts a component planning user interface 1000 as used in systems for implementing improved asset maintenance planning capabilities in asset intensive enterprises. As an option, one or more instances of component planning user interface 1000 or any aspect thereof may be implemented in the context of the architecture and functionality of the embodiments described herein. Also, the component planning user interface 1000 or any aspect thereof may be implemented in any desired environment.

The user interface of FIG. 10 depicts a material planning schedule at the time granularity of one day. The example shown is for a particular battery component named “AR_Battery” (see asset of interest 1010). Included in the display is a line showing a projected available balance over time (see totals 1008). The granularity is one day, and accordingly the totals 1008 are given in day-by-day columns. As shown, the projected available balance is “0.0” during the shown portion of the current year, and becomes “−69.0” in the shown next year. These totals have many contributors. Strictly as examples, the component planning user interface 1000 totals up based on:
Subtotals from planned repair work orders 1012,
Subtotals from defective part demand 1014,
Subtotals from a forecast of returns (see returns forecast 1016),
Subtotals from defective units on-hand 1018,
Subtotals from defective units in-transit 1020,
Subtotals from a projected available balance of incoming defective (and rebuildable) components 1022,
Subtotals from maintenance work order demands 1024,
Subtotals from a forecast based on maintenance work order demands 1026,
Subtotals from planned defective transfer orders 1028,
Subtotals from a forecast based on planned defective part demand 1030, and
Subtotals from external repair orders 1032.

The subtotals from external repair orders 1032 models the situation when an asset which might have been repaired in an enterprise-managed repair depot (e.g., Seattle repair depot, Chicago repair depot, etc.) is instead sent to an external repair depot. There may be many of such occurrences, and the subtotals from external repair orders 1032 captures the total as modeled in the user-specified granularity.

FIG. 11 depicts a resource planning user interface 1100 as used in systems for implementing improved asset maintenance planning capabilities in asset intensive enterprises. As an option, one or more instances of resource planning user interface 1100 or any aspect thereof may be implemented in the context of the architecture and functionality of the embodiments described herein. Also, the resource planning user interface 1100 or any aspect thereof may be implemented in any desired environment.

The user interface of FIG. 11 depicts a resource planning schedule at the time granularity of one day. The example shown is for a particular resource named “A&P-SFM” (see resource demand requirement 1110). Included in the display is a line for showing a projected available balance of hours over time (see total available hours 1108). Strictly as examples, the resource planning user interface 1100 totals up based on:
Subtotals from net hour available 1112,
Subtotals from maintenance work orders 1024, and
Subtotals from external repair orders 1032.

Also shown in resource planning user interface 1100 are:
Capacity load ratio 1114, and
Subtotals of hours allocated to accomplish planned repair work orders 1118.

Using such a resource planning user interface, a manager can determine if resources need to be hired, trained, or otherwise positioned for work to be performed at a particular site on a particular day. In some cases, an available resource (e.g., a repair specialist certified for jet engine repair) can be moved from one location to another location so as to position the resource for work at the particular site by a particular day.

While the foregoing discusses aspects of resources that need to be hired, trained, or otherwise positioned for work to be performed at a particular site on a particular day, it is often also true that certain assets need to be identified and positioned for work to be performed at a particular site on a particular day. In an enterprise such as a national enterprise or a global enterprise, such assets may be available through several channels. For example, an asset may be available or scheduled to become available based on a new purchase, or a based on an asset from an earlier purchase that is in transit, or from a returned item or from a forecast for a returned item, or based on an asset that can be transferred from one site to another site (or based on a forecast thereto). An information flow to accommodate is discussed in the following FIG. 12.

FIG. 12 depicts a maintenance work order information flow diagram 1200 as used in systems for implementing improved asset maintenance planning capabilities in asset intensive enterprises. As an option, one or more instances of maintenance work order information flow diagram 1200 or any aspect thereof may be implemented in the context of the architecture and functionality of the embodiments described herein. Also, the maintenance work order information flow diagram 1200 or any aspect thereof may be implemented in any desired environment.

For long term planning, it is often not required to have accurate timings pertaining to each individual maintenance work order. Instead, aggregating material and resource requirements across a set of similar maintenance work helps improve long-range planning performance and, at the same time, performing such long range planning does not have any significant impact on the quality or utility of the current period plan outputs.

As earlier discussed, a supply chain planning module 112 can create work orders in the form of maintenance work orders 317. In some cases, a work order is initially generated at a moment in time, possibly long before the work is to be started, and the needed assets, components, parts, materials and/or resources many not be available at that earlier point in time. In a later timeframe, a maintenance work order is generated in sufficient detail so as accurately predict that the needed assets, components, parts, materials and/or resources are available in time to perform the maintenance work order on a prescribed schedule. The flow of information to predict or determine that the needed assets, components, parts, materials and/or resources will be available on a prescribed schedule can include information flows arising from multiple sources. As an example, the maintenance work order information flow diagram 1200 includes information flow inputs in the form of an input returns forecast 1202, service parts new buy supplier capacity 1204, and upstream service parts supplies 1206. In some cases, and as shown in FIG. 12, the shown inputs might refer to multiple units of the same asset type. Such multiple units can be aggregated into a single larger maintenance work order unit for the purpose of capturing maintenance work order material and resource requirements without the computational burden of dealing with many thousands of individual maintenance work orders.

Maintenance work orders with their respective demands fulfilled or at least predicted to be fulfilled can be generated by a supply chain management function and delivered to a maintenance operations function. For example, and as shown in FIG. 3, the supply chain planning module 112 can create work orders in the form of maintenance work orders 317. Further, in some situations (e.g., in the event that the aforementioned aggregations of availability exceed the demands), then the supply chain planning module 112 can deliver data records pertaining to the forecasted availability 316 to a maintenance operations module 116, and the maintenance operations module will adjust maintenance tempo.

FIG. 13 depicts an aggregation reconciliation flow 1300 for combining repair depot demands and supply chain demands as used in systems for implementing improved asset maintenance planning capabilities in asset intensive enterprises.

Aggregation (e.g., aggregation for forecasting purposes) can occur in many settings within an enterprise and/or over many sets of data items. Strictly as one example, aggregation can be performed over a set of work orders, and in the example as shown in FIG. 13, a work order can be operated upon in two contexts: (1) in a repair depot as the work is being performed, and (2) in a supply chain management function where the supply chain management function periodically monitors the availability of assets and resources demanded by a particular work order. Changing conditions over time may cause a previously assigned asset to become unavailable (e.g., a newly ordered component arrived on time, but was defective upon arrival to the repair depot). Or, an asset that was scheduled to arrive on a particular date (and assigned to a work order with a matching demand) incurs a delay in transit (e.g., delayed at a waypoint). In such cases and as shown, the effects (if any) on the supply chain function and the effects (if any) on the repair depot function can be reconciled. In some cases, and as depicted in FIG. 3, the aforementioned supply chain function can be implemented by a supply chain planning module 312 and the repair depot function can be implemented using a maintenance operations module 116.

FIG. 14 depicts a flow for coordinating repairs with on-hand materials 1400 as used in systems implementing improved asset maintenance planning capabilities in asset intensive enterprises.

As shown in the flow of FIG. 14, a defective asset (e.g., defective rebuildable item 1402) is repaired and tagged as a usable asset (e.g., rebuildable items 1404). In some cases the repair work commences at T₀ (as shown) and a usable asset can be predicted to become available at the conclusion of the scheduled repair activity after incurring a repair lead time 1408₁. In other cases the repair work has already commenced at a time earlier than T₀, and a usable asset can be predicted to become available at the conclusion of the in-process repair activity after incurring a repair lead time 1408₂. Predicted repair times are based on average times, assuming any needed components, materials or resources are available on-hand at the time the repair activity commences. The lead time needed to deliver the usable asset can be selected based on the earlier-to-complete repair. The usable item can be included in any mapping of assets or components to corresponding demands

In some cases, maintenance work order demands can specify a preference or requirement for an item to be a new item, or for a repairable (rebuildable) item, or for transferred-across items. In some cases, a maintenance work order comprises a demand for materials or resources to be available on-hand at the time the repair activity commences, and a supply chain planning module 112 or other module can determine a source for the demands (e.g., depending on a preference or requirement for a newly purchased or on-hand or transferred item). For purchased and transferred items, supply chain planning module 112 can source the supply from a supplier or from another organization. For repairable items, supply chain planning module 112 can use an existing supply (on hand, maintenance work orders or external repair orders) and also can create new planned repair work orders. The supply chain planning module 112 also plans the reverse supply chain i.e., the supply chain to account for defective items. Repair orders can generate demand for defective parts (e.g., part demand, planned part demand, etc.). Demand for defective parts can be satisfied using a returns forecast. A returns forecast could be could be originated by a different organization in which case the supply chain planning module 112 will consider sourcing rules to transfer defective parts across organizations.

As illustrated in FIG. 14, a usable item (e.g., rebuildable items 1404) can be yielded from either a new repair activity or from an in-process repair activity. Historical records can be used to calculate how many usable units are produced by repairing a defective unit. For example, if the yield is known or predicted to be 80%, then every 10 defective items repaired will result in 8 usable items.

Reverse supply chain planning can also be performed. Reverse supply chain planning is the process of planning for the repair of defectives items. For example, complex assemblies known as line replaceable units (LRUs) are removed and replaced during asset maintenance. This process sometimes creates defective LRUs which are routed to an assembly repair shop for repair. The repair shop disassembles the LRU into components known as shop replaceable units (SRUs). These SRUs are inspected and either reinstalled back into an LRU, routed to component repair shop, or scrapped. The SRUs that are routed for repair are disassembled into sub-shop replaceable units (sub-SRUs). These sub-SRUs are inspected and either reinstalled back into an SRU or routed for repair or scrapped.

FIG. 15 depicts a flow for forecasting based on repairs and returns 1500 as used in systems implementing improved asset maintenance planning capabilities in asset intensive enterprises.

As shown in FIG. 15, an inventory 1502 might comprise many contributors to the inventory. For example, and as shown, inventory might comprise stock inventory 1504, a spares inventory 1503, a work-in-process inventory 1506, and an accounting of incoming returns 1508. Inventory from any of the aforementioned sources might be scrutinized so as to classify the inventory item as usable or defective (e.g., using classifier 1509₁). Moreover, the classification might be based on a classifier that is configured specifically to classify based on the source. For example, an item in stock inventory 1504 might have been subjected to an incoming inspection, and the incoming inspection procedure itself serves as a classifier (e.g., classifier 1509₂). In another situation, incoming returns 1508 might be subject to a different sort of incoming inspection, and a differently configured classifier (e.g., classifier 1509₃) might be used on incoming returns. For example, an incoming return might be classified as usable if the incoming return was in the original unopened packaging.

Over time, the trends in determination of an item in inventory as usable or defective is considered by a supply chain function. For example, and as shown, the supply chain planning module 112 retrieves a history of records pertaining to the frequency of finding defective components (e.g., see retrieve history 1510) and determines the likelihood of occurrence of a return and/or the likelihood of occurrence of a defective item (e.g., see operation 1508). The likelihood of a return and/or a forecast of incoming defective items (e.g., see operation 1511) can be used in limiting the quantity of new buy orders (e.g., see operation 1512).

In certain embodiments, the incoming returns forecast can be fed in manually (using flat files) and also automatically derived from any enterprise-wide asset management systems and/or from maintenance work orders that include a removal of defective parts as part of the work order content. In some embodiments a defective forecast is formed by setting the defective returns forecast for rebuildable items to be the quantity:

[(1−scrap rate)×projected removals for rebuildable items aggregated across all work orders within a particular planning period].

The embodiment of FIG. 15 also depicts an approach to model a defective items pool 1520. For example, materials that exit a work-in-process activity (e.g., 1506) can be classified as defective or usable, and defective items can become scrap 1513. A supply chain planning module 112 can incorporate the reverse supply chain and can maintain information of how much available inventory of the item is “defective” versus “usable” versus scrap.

As indicated above, the supply chain planning module 112 also considers a forward stream of supply called incoming returns. A forecast of incoming returns can be retrieved from external sources or can be calculated by supply chain planning module 112 based on projected removal of defective items from maintenance work orders in the future.

Some implementations employ an inventory reservation system. For example, a maintenance operations module 116 can establish reservations between an existing supply and an existing demand Reservation types used in maintenance operations module 116 include:
Match (reserve) internal requisitions (supply) to maintenance work order (demand)
Match (reserve) maintenance work orders (supply) to maintenance work orders (demand).
Match (reserve) on hand inventory (supply) to maintenance work orders (demand).

All three reservations types are honored by supply chain planning module 112. Moreover, the supply chain planning module 112 will ensure that specific supply orders are pegged to specific demand orders based on the details contained in the reservations established in maintenance operations module 116. In some cases, the reservation system can result in over-aggressive ordering. For example, a jet engine replacement might be reserved to a specific forecasted event, yet that event might not ever occur, and if not, the result is an ‘extra’ jet engine. Various inventory optimization techniques can be employed to mitigate over (or under) forecasting to maintain inventor levels. In some embodiments, inventory optimization implements controls, checks and balances such as:
Objectives. Rules serve to enforce service levels, enforce budgets, etc.
Constraints. Thresholds or limits as to production capacity, warehouse capacity, minimum safety stock, etc.
Variability Inputs. Statistical ranges used to model responsiveness to demand variability, lead time variability, etc.

Certain inventory optimization techniques consider some or all of the above in the context of a multi-echelon supply chain model that is constructed based on sourcing rules, BOM content, lead time, and other inputs.

For maintenance planning, optimization logic is employed to consider maintenance demand and demand variability as part of the overall demand/demand variability inputs. Also, optimization logic considers repair lead times and lead time variability.

The foregoing describes an improved approach to implement asset intensive planning. Described are various embodiments directed to approaches to implement the supply chain planning function including advanced approaches to implement maintenance calculations, repair planning, and reverse supply chain planning.

Any of the techniques disclosed herein can be used singly or in combination in systems implementing improved asset maintenance planning capabilities in asset intensive enterprises. Moreover any functional block used to implement any operations involved in the disclosed techniques can communicate with any other functional block. For example, communication between functional blocks can occur over the heretofore discussed integration paths, or can occur over other paths not shown, or can occur using combinations of storage and retrieval operations (e.g., using a database storage facility and a database engine).

What has been heretofore described are improved approaches to implement asset-intensive supply chain planning and improved approaches to perform demand forecasting. These approaches produces much more accurate asset-related spare parts forecasts. With respect to ongoing maintenance of high-value enterprise assets, this approach allows the system to use aspects of a schedule maintenance plan in combination with historical maintenance plan performance, and further in combination with learned information about actual projected asset usages, operational tempos, and maintenance tempos. Thus, asset-intensive supply chain planning and improved approaches to forecast demand can therefore perform at levels of precision that are not possible with prior business applications.

### ADDITIONAL EMBODIMENTS OF THE DISCLOSURE

### Additional Practical Application Examples

FIG. 16 is a block diagram of a system for improved asset tracking in asset intensive enterprises. As shown, system 1600 comprises at least one processor and at least one memory, the memory serving to store program instructions corresponding to the operations of the system. As shown, an operation can be implemented in whole or in part using program instructions accessible by a module. The modules are connected to a communication path 1605, and any operation can communicate with other operations over communication path 1605. The modules of the system can, individually or in combination, perform method operations within system 1600. Any operations performed within system 1600 may be performed in any order unless as may be specified in the claims.

The embodiment of FIG. 16 implements a portion of a computer system, shown as system 1600, comprising a computer processor to execute a set of program code instructions (see module 1610) and modules for accessing memory to hold program code instructions to perform: configuring a computing system having at least one processor to perform a process (see module 1620); receiving a database record corresponding to an individually identified asset to be individually tracked through a corresponding asset lifecycle (see module 1630); generating a candidate order database entry for a component or supply constituent to the individually identified asset, wherein the component or supply constituent to the individually identified asset is identified in an asset specific scheduled maintenance plan (see module 1640); accessing a database pertaining to at least one of a plurality of maintenance depots to retrieve database records, at least some of the database records referring to the asset specific scheduled maintenance plan for the individually identified asset (see module 1650); and adjusting the candidate order based at least in part on the retrieved database records to form a maintenance adjusted order (see module 1660).

FIG. 17 is a block diagram of a system for improved asset forecasting in asset intensive enterprise. As shown, system 1700 comprises at least one processor and at least one memory, the memory serving to store program instructions corresponding to the operations of the system. As shown, an operation can be implemented in whole or in part using program instructions accessible by a module. The modules are connected to a communication path 1705, and any operation can communicate with other operations over communication path 1705. The modules of the system can, individually or in combination, perform method operations within system 1700. Any operations performed within system 1700 may be performed in any order unless as may be specified in the claims.

The embodiment of FIG. 17 implements a portion of a computer system, shown as system 1700, comprising a computer processor to execute a set of program code instructions (see module 1710) and modules for accessing memory to hold program code instructions to perform: configuring a computing system having at least one processor to perform a process, the process comprising (see module 1720); receiving database record corresponding to an individually identified asset to be individually tracked through a corresponding asset lifecycle (see module 1730); receiving an asset-specific scheduled maintenance plan for the individually identified asset (see module 1740); recording events pertaining to the individually identified asset over at least a portion of the asset-specific scheduled maintenance plan (see module 1750); storing a series of recorded events pertaining to performance of the asset-specific scheduled maintenance plan of the individually identified asset into a learning model (see module 1760); and using the learning model to predict a future demand, wherein the predicted future demand comprises a forecast for items in quantities that are not given in the asset-specific scheduled maintenance plan for the individually identified asset (see module 1770).

### System Architecture Overview

### Additional System Architecture Examples

FIG. 18 depicts a block diagram of an instance of a computer system 1800 suitable for implementing an embodiment of the present disclosure. Computer system 1800 includes a bus 1806 or other communication mechanism for communicating information, which interconnects subsystems and devices, such as a processor 1807, a system memory 1808 (e.g., RAM), a static storage device (e.g., ROM 1809), a disk drive 1810 (e.g., magnetic or optical), a data interface 1833, a communication interface 1814 (e.g., modem or Ethernet card), a display 1811 (e.g., CRT or LCD), input devices 1812 (e.g., keyboard, cursor control), and an external data repository 1831.

According to one embodiment of the disclosure, computer system 1800 performs specific operations by processor 1807 executing one or more sequences of one or more instructions contained in system memory 1808. Such instructions may be read into system memory 1808 from another computer readable/usable medium, such as a static storage device or a disk drive 1810. In alternative embodiments, hard-wired circuitry may be used in place of or in combination with software instructions to implement the disclosure. Thus, embodiments of the disclosure are not limited to any specific combination of hardware circuitry and/or software. In one embodiment, the term “logic” shall mean any combination of software or hardware that is used to implement all or part of the disclosure.

The term “computer readable medium” or “computer usable medium” as used herein refers to any medium that participates in providing instructions to processor 1807 for execution. Such a medium may take many forms, including but not limited to, non-volatile media and volatile media. Non-volatile media includes, for example, optical or magnetic disks, such as disk drive 1810. Volatile media includes dynamic memory, such as system memory 1808.

Common forms of computer readable media includes, for example, floppy disk, flexible disk, hard disk, magnetic tape, or any other magnetic medium; CD-ROM or any other optical medium; punch cards, paper tape, or any other physical medium with patterns of holes; RAM, PROM, EPROM, FLASH-EPROM, or any other memory chip or cartridge, or any other non-transitory medium from which a computer can read data.

In an embodiment of the disclosure, execution of the sequences of instructions to practice the disclosure is performed by a single instance of the computer system 1800. According to certain embodiments of the disclosure, two or more computer systems 1800 coupled by a communications link 1815 (e.g., LAN, PTSN, or wireless network) may perform the sequence of instructions required to practice the disclosure in coordination with one another.

Computer system 1800 may transmit and receive messages, data, and instructions, including programs (e.g., application code), through communications link 1815 and communication interface 1814. Received program code may be executed by processor 1807 as it is received and/or stored in disk drive 1810 or other non-volatile storage for later execution. Computer system 1800 may communicate through a data interface 1833 to a database 1832 on an external data repository 1831. A module as used herein can be implemented using any mix of any portions of the system memory 1808, and any extent of hard-wired circuitry including hard-wired circuitry embodied as a processor 1807.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are, accordingly, to be regarded in an illustrative sense rather than in a restrictive sense.

What is claimed is:

1. A method comprising:
using a computing system having at least one processor to perform a process, the process comprising:
receiving a database record corresponding to an individually identified asset to be individually tracked through a corresponding asset lifecycle;
generating a candidate order database entry for a component or supply constituent to the individually identified asset, wherein the component or supply constituent to the individually identified asset is identified in an asset specific scheduled maintenance plan;
accessing a database pertaining to at least one of a plurality of maintenance depots to retrieve database records, at least some of the database records referring to the asset specific scheduled maintenance plan for the individually identified asset; and
adjusting the candidate order based at least in part on the retrieved database records to form a maintenance adjusted order.

2. The method of claim 1, wherein the individually identified asset is at least one of, a component, a sub-component, and a spare part.

3. The method of claim 1, further comprising placing the maintenance adjusted order to a supplier using a supply chain management business application.

4. The method of claim 1, further comprising analyzing or displaying at least some of the database records referring to the asset specific scheduled maintenance plan for the individually identified asset.

5. The method of claim 1, further comprising analyzing or displaying at least one of, subtotals from planned repair work orders, subtotals from defective part demand, subtotals from a returns forecast, subtotals from defective units on-hand, subtotals from defective units in-transit, subtotals from a projected available balance of incoming defective components, subtotals from maintenance work order demands, subtotals from a forecast based on maintenance work order demands, subtotals from planned defective transfer orders, subtotals from a forecast based on planned defective part demand, and subtotals from external repair orders.

6. The method of claim 1, wherein the asset-specific scheduled maintenance plan for the individually identified asset comprises a time duration that the individually identified asset is scheduled to be out of service.

7. The method of claim 1, wherein at least some of the database records referring to the asset-specific scheduled maintenance plan for the individually identified asset comprises a maintenance work order.

8. The method of claim 7, wherein the maintenance work order comprises a demand for materials, tools or resources to be available on-hand when the asset-specific scheduled maintenance plan for the individually identified asset commences.

9. The method of claim 8, wherein the on-hand materials or resources are scheduled to become available upon conclusion of a scheduled repair activity pertaining to a second individually identified asset.

10. The method of claim 8, wherein the tool is scheduled to become available after a transportation latency period commencing at conclusion of a scheduled repair activity pertaining to a second individually identified asset.

11. A computer program product embodied in a non-transitory computer readable medium, the computer readable medium having stored thereon a sequence of instructions which, when executed by a processor causes the processor to execute a process, the process comprising:
receiving a database record corresponding to an individually identified asset to be individually tracked through a corresponding asset lifecycle;
generating a candidate order database entry for a component or supply constituent to the individually identified asset, wherein the component or supply constituent to the individually identified asset is identified in an asset specific scheduled maintenance plan;
accessing a database pertaining to at least one of a plurality of maintenance depots to retrieve database records, at least some of the database records referring to the asset specific scheduled maintenance plan for the individually identified asset; and
adjusting the candidate order based at least in part on the retrieved database records to form a maintenance adjusted order.

12. The computer program product of claim 11, wherein the individually identified asset is at least one of, a component, a sub-component, and a spare part.

13. The computer program product of claim 11, further comprising instructions for placing the maintenance adjusted order to a supplier using a supply chain management business application.

14. The computer program product of claim 11, further instructions for comprising analyzing or displaying at least some of the database records referring to the asset specific scheduled maintenance plan for the individually identified asset.

15. The computer program product of claim 11, further comprising instructions for analyzing or displaying at least one of, subtotals from planned repair work orders, subtotals from defective part demand, subtotals from a returns forecast, subtotals from defective units on-hand, subtotals from defective units in-transit, subtotals from a projected available balance of incoming defective components, subtotals from maintenance work order demands, subtotals from a forecast based on maintenance work order demands, subtotals from planned defective transfer orders, subtotals from a forecast based on planned defective part demand, and subtotals from external repair orders.

16. The computer program product of claim 11, wherein the asset-specific scheduled maintenance plan for the individually identified asset comprises a time duration that the individually identified asset is scheduled to be out of service.

17. The computer program product of claim 11, wherein at least some of the database records referring to the asset-specific scheduled maintenance plan for the individually identified asset comprises a maintenance work order.

18. The computer program product of claim 17, wherein the maintenance work order comprises a demand for materials, tools or resources to be available on-hand when the asset-specific scheduled maintenance plan for the individually identified asset commences.

19. A system comprising:
a supply chain planning module to receive a database record corresponding to an individually identified asset to be individually tracked through a corresponding asset lifecycle;
a maintenance scheduler to generate a candidate order database entry for a component or supply constituent to the individually identified asset, wherein the component or supply constituent to the individually identified asset is identified in an asset specific scheduled maintenance plan;
a maintenance operations module to access a database pertaining to at least one of a plurality of maintenance depots to retrieve database records, at least some of the database records referring to the asset specific scheduled maintenance plan for the individually identified asset; and
a module to adjust the candidate order based at least in part on the retrieved database records to form a maintenance adjusted order.

20. The system of claim 19, wherein the individually identified asset is at least one of, a component, a sub-component, and a spare part.
